(19) United States
(12) Patent Application Publication
(10) Pub. No.: US 2012/0132179 A1
(43) Pub. Date: May 31, 2012

(54) FUEL VAPOR LEAKAGE INSPECTION APPARATUS

(75) Inventors: Mitsuyuki KOBAYASHI, Gamagori-city (JP); Taiki Yasuzaka, Nagoya-city (JP)

(73) Assignee: DENSO CORPORATION, Kariya-city (JP)

(21) Appl. No.: 13/304,804

(22) Filed: Nov. 28, 2011

(30) Foreign Application Priority Data
Nov. 29, 2010 (JP) 2010-264978

(51) Int. Cl. F02M 33/02

(52) U.S. Cl. 123/518

(57) ABSTRACT

A canister attachment portion includes a canister passage communicating with an inside of a canister. An air passage has a first end connected to communicate with the canister passage and a second end connected with atmosphere. A pumping device increases and decreases an inside pressure of the canister, and one end of the pumping device is connected to communicate with the canister passage and the other end of the pumping device is connected to the air passage. A switching valve switches the canister passage to communicate with the air passage or the pumping device. A throttle is provided in the bypass passage. A housing defines the air passage and a bypass passage, and accommodates the pumping device, the switching valve and the throttle. The filter is provided in the air passage and is accommodated in the housing.

### CROSS REFERENCE TO RELATED APPLICATION

This application is based on and incorporates herein by reference Japanese Patent Application No. 2010-264978 filed on Nov. 29, 2010.

### BACKGROUND OF THE INVENTION

1. Field of the Invention

The present invention relates to a fuel vapor leakage inspection apparatus.

2. Description of Related Art

A fuel vapor leakage inspection apparatus that detects fuel vapor leaked from a fuel tank has been known. The fuel vapor leakage inspection apparatus includes a filter for collecting foreign objects such as dust and fine particles at the time of taking air from an outside of the fuel vapor leakage inspection apparatus. For example, Japanese Patent Publication JP 2006-051928A (corresponding to US 2006-0032482A1) teaches a fuel vapor leakage inspection apparatus, which includes the filter at the vicinity of a fuel supply port of a vehicle.

However, in this fuel vapor leakage inspection apparatus, at the time of inspecting the fuel vapor leakage, a pump is activated to reduce an inside pressure of the fuel tank. The pump radiates noise of air pulses, and transmitting noise is generated by vibration in the pump. Further, when a switching valve switches a canister passage communicating with a canister, parts of the switching valve are contacted with each other, thereby generating noise. When a certain period of time is passed after the engine is stopped, fuel vapor leakage starts being inspected. The noises are generated at the time of the operation of the fuel vapor inspection apparatus, and spread out of the vehicle.

### SUMMARY OF THE INVENTION

The present invention addresses the above disadvantage. According to the present invention, there is provided a fuel vapor leakage inspection apparatus, which detects a leakage of a fuel vapor from a fuel tank through a canister that absorbs the fuel vapor. The fuel vapor leakage inspection apparatus includes a canister attachment portion, an air passage, a pumping device, a switching valve, a bypass passage, a throttle, a housing, and a filter. The canister attachment portion includes a canister passage communicating with an inside of the canister. The air passage has a first end connected to communicate with the canister passage and a second end connected with atmosphere. The pumping device increases and decreases an inside pressure of the canister, and one end of the pumping device is connected to communicate with the canister passage and the other end of the pumping device is connected to the air passage. The switching valve switches the canister passage to communicate with the air passage or the pumping device. One end of the bypass passage is connected to the canister passage and the other end of the bypass passage is connected to a passage defined between the pumping device and the switching valve. The throttle is provided in the bypass passage. The housing defines the air passage and the bypass passage, and accommodates the pumping device, the switching valve and the throttle. The filter is provided in the air passage and is accommodated in the housing.

### BRIEF DESCRIPTION OF THE DRAWINGS

The invention, together with additional objectives, features and advantages thereof, will be best understood from the following description, the appended claims and the accompanying drawings in which:

FIG. 1 is a schematic view of evaporative fuel handling equipment that includes a fuel vapor leakage inspection apparatus according to a first embodiment of the present invention;

FIG. 2A is a cross-sectional view of the fuel vapor leakage inspection apparatus according to the first embodiment of the present invention, FIG. 2B is a cross-sectional view taken along line IIB-IIB in FIG. 2A, and FIG. 2C is a view taken in a direction of an arrow IIC in FIG. 2A;

FIG. 3A is a cross-sectional view of a fuel vapor leakage inspection apparatus according to a second embodiment of the present invention, FIG. 3B is a cross-sectional view taken along line IIIB-IIIB in FIG. 3A, and FIG. 3C is a view taken in a direction of an arrow 111C in FIG. 3A;

FIG. 4A is a cross-sectional view of a fuel vapor leakage inspection apparatus according to a third embodiment of the present invention, FIG. 4B is a cross-sectional view taken along line IVB-IVB in FIG. 4A, and FIG. 4C is a view taken in a direction of an arrow IVC in FIG. 4A;

FIGS. 5A, 5B and 5C are modification examples of the third embodiment that are viewed from a side of a fuel vapor leakage sensing unit that is opposite from a canister attachment portion;

FIG. 6A is a cross-sectional view of a fuel vapor leakage inspection apparatus according to a fourth embodiment of the present invention, and FIG. 6B is a view taken in a direction of an arrow VIB in FIG. 6A.

### DETAILED DESCRIPTION OF THE INVENTION

Various embodiments of the present invention will be described with reference to the accompanying drawings. In the following embodiments, similar components are indicated by the same reference numerals and will not be redundantly described to simplify the description. In each of the following embodiments, if only a part of a structure is described, the remaining part of the structure is the same as that of the previously described embodiment(s). Any one or more components of any one of the following embodiments may be combined with the components of the other one of the following embodiments without departing a scope and spirit of the present invention.

### First Embodiment

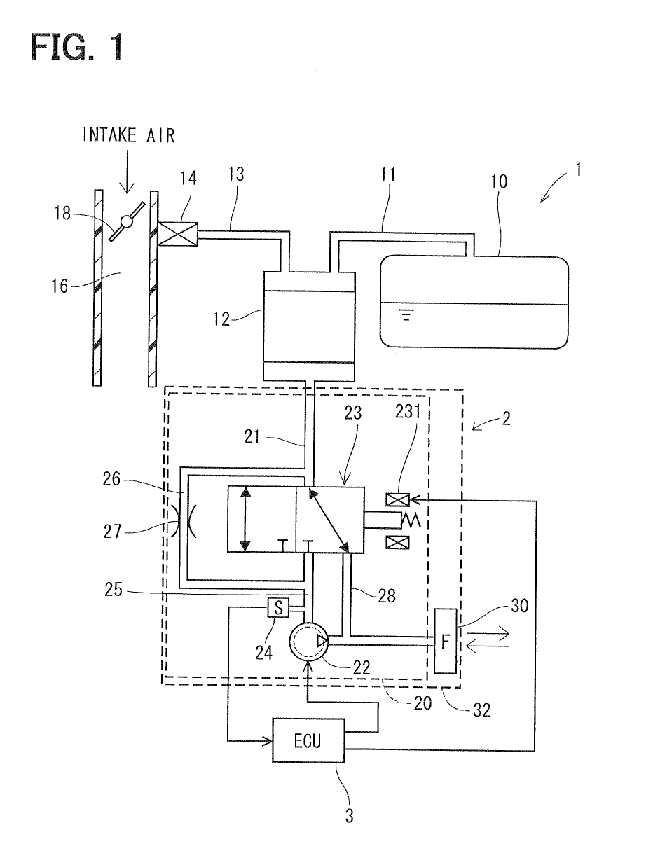

As shown in FIG. 1, an evaporative fuel handling equipment 1 includes a fuel tank 10, a canister 12, and a fuel vapor leakage inspection apparatus 2. The fuel tank 10 and the canister 12 are connected to each other through a first purge tube 11. The canister 12 and a portion of an intake passage 16 adjacent to a throttle valve 18 are connected to each other through a second purge tube 13. The second purge tube 13 is provided with a purge valve 14. Evaporative fuel generated in the fuel tank 10 flows into the canister 12 through the first purge tube 11. Then the evaporative fuel is absorbed by an activated carbon adsorbent arranged within the canister 12. The purge valve 14 is an electromagnetic valve. Controlling the position of the purge valve 14 results in adjusting the amount of the evaporative fuel that is purged from an inside of the canister 12 into an inside of the intake passage 16.

The fuel vapor leakage inspection apparatus 2 and the canister 12 are connected to each other through a canister channel 21. The fuel vapor leakage inspection apparatus 2 includes a pump 22, a switching valve 23, a pressure sensor 24, a bypass passage 26, a fuel vapor leakage sensing unit 20, and a filter 30. The pump 22 is used as a pumping device to pressurize and depressurize the gas in the fuel vapor leakage sensing unit 20. The fuel vapor leakage sensing unit 20 includes a reference orifice 27 and an air passage 28. The reference orifice 27 is used as a throttle of gas flowing through the bypass passage 26. The fuel vapor leakage sensing unit 20 and the filter 30 are accommodated in a housing 32. The fuel vapor leakage inspection apparatus 2 inspects a leakage of the fuel vapor from the fuel tank 10.

The pump 22 of the fuel vapor leakage sensing unit 20 is connected to the switching valve 23 through a pump passage 25, which is provided with the pressure sensor 24. The pump 22 reduces the pressure of an inside of the tank 10 via the canister channel 21 and the pump passage 25, which are communicated with each other by an operation of the switching valve 23. The operation of the switching valve 23 is discussed below. The pump passage 25 is connected to the bypass passage 26, which is provided with the reference orifice 27. The pump 22 is activated by a signal output from an electronic control unit (ECU) 3.

The switching valve 23 of the fuel vapor leakage sensing unit 20 is an electromagnetic valve. As shown in FIG. 1, when power to a coil 231 is cut off, the switching valve 23 causes the canister channel 21 to communicate with the air passage 28, and the air taken from an outside of the fuel vapor leakage inspection apparatus 2 flows through the air passage 28. When the coil 231 is energized, the switching valve 23 causes the canister 12 to communicate with the pump 22 through not the bypass passage 26 but the canister channel 21 and the pump passage 25. Then, the pressure sensor 24, which is provided in the pump passage 25, detects a pressure of an inside of the pump passage 25. The reference orifice 27, which is arranged in the bypass passage 26, has a hole size corresponding to an upper limit of allowable flow amount of the gas including the evaporative fuel from the fuel tank 10.

The filter 30 is provided in the air passage 28. When the fuel vapor from the fuel tank 10 is absorbed by the canister 12, or when the pump 22 reduces the inside pressure of the fuel tank 10, the air flowing from the canister 12 is discharged to outside atmosphere through the filter 30. When the fuel vapor absorbed in the canister 12 is sent to the intake passage 16, or when a reference pressure is detected in a fuel vapor leakage inspection that is discussed below, air is introduced from the outside of the fuel vapor leakage inspection apparatus 2 through the filter 30. At this time, the filter 30 collects foreign objects that are included in the air flowing from the outside of the fuel vapor leakage inspection apparatus 2 to the canister 12. Arrows shown in FIG. 1 indicates a flow of the air.

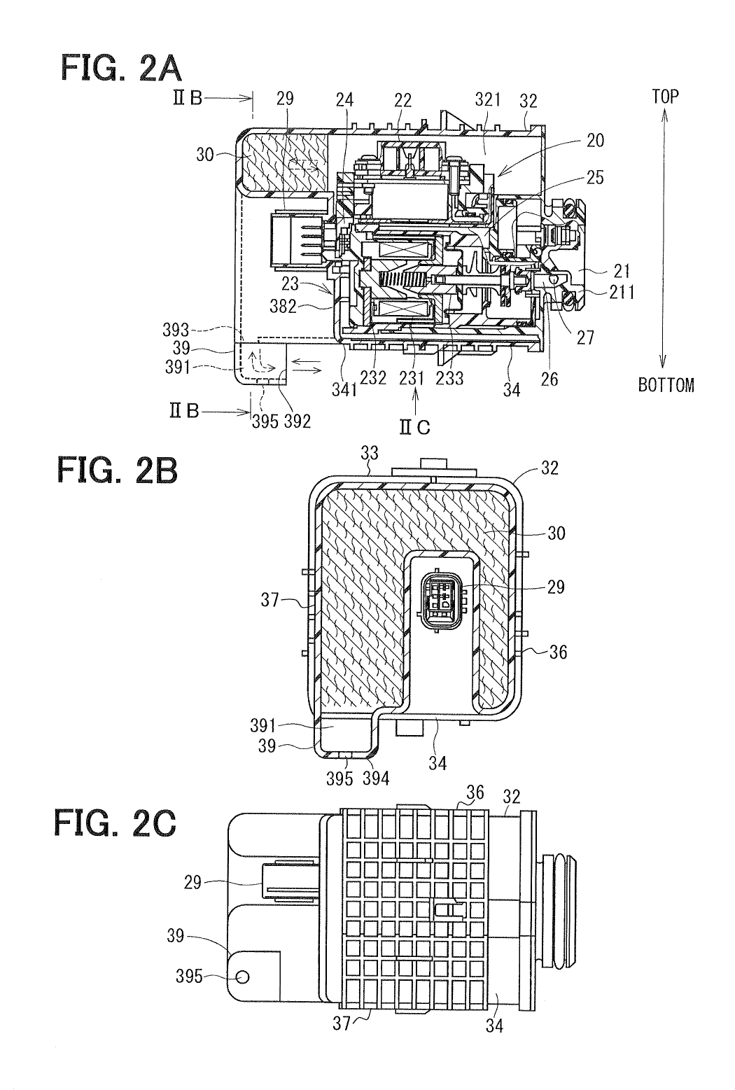

Next, a structure of the fuel vapor leakage inspection apparatus 2 will be described with reference to FIGS. 2A, 2B and 2C. As shown in FIG. 2A, the fuel vapor leakage sensing unit 20 is a module that integrally includes the pump 22, the switching valve 23, and the pressure sensor 24. The housing 32 accommodates the fuel vapor leakage sensing unit 20. A canister attachment portion 211 of the housing 32 is fitted to a mounting hole of an outer sidewall of the canister 12. Therefore, the pump 22 is located in an upper side of the switching valve 23 in a vertical direction (a top-to-bottom direction of FIG. 2A). The pressure sensor 24 is arranged on a side that is opposite from the canister attachment portion 211 relative to the switching valve 23. A connector 29 is arranged on a side that is opposite from the canister attachment portion 211 relative to the pressure sensor 24. The connector 29 receives a power supply from the outside of the fuel vapor leakage sensing unit 20.

The filter 30 is arranged within a housing interior space 321 at a side that is opposite from the canister attachment portion 211. The filter 30 is made of a non-woven fabric. As shown in FIG. 2B, the filter 30 is arranged between an upper wall 33 of the housing 32 and the connector 29. The filter 30 is also arranged between a back wall 37 of the housing 32 and the connector 29, and between a front wall 36 of the housing 32 and the connector in FIG. 2B. Arrows shown in FIG. 2A indicates a flow of air.

As shown in FIG. 2B, an air communicating portion 39 is provided on an outer face 341 of a lower wall 34 of the housing 32. The air communicating portion 39 defines an air communicating passage 391. The air communicating passage 391 causes the housing interior space 321 to communicate with air outside of the housing 32, i.e., atmosphere. The air communicating passage 391 causes an air opening 392 to communicate with a filter inlet 393. The air communicating passage 391 has a labyrinth structure including a bent portion. Specifically, a wall surface that forms the air communicating portion 39 is bent along the flow direction of the air passing through the air communicating passage 391. Therefore, an opening direction of the air opening 392 is generally parallel to a horizontal direction in FIG. 2A. However, an opening direction of the filter inlet 393 is generally parallel to a vertical direction in FIG. 2A. Therefore, the opening directions of the air opening 392 and the filter inlet 393 are different from each other. A drain hole 395 is defined in a lower wall 394 of the air communicating portion 39. The drain hole 395 drains water, which is pooled in the air communicating passage 391, out of the passage 391. The air communicating passage 391 is an end portion of the air passage 28 that connects with outside atmosphere.

Next, a function of the fuel vapor leakage inspection apparatus 2 according to the first embodiment will be described based on FIG. 1. When a predetermined period passes after the operation of an engine of a vehicle is stopped, the ECU 3 is activated by a soak timer (not shown), thereby starting to detect the fuel vapor leakage of the fuel tank 10. When detecting the fuel vapor leakage, atmospheric pressure is measured for correcting an error caused by the altitude of a place, on which the vehicle is parked. The measurement of the atmospheric pressure is conducted by the pressure sensor 24, which is provided in the pump passage 25. When the coil 231 is not energized, the air passage 28 and the pump passage 25 are communicated with each other via the switching valve 23 and the bypass passage 26. Therefore, the atmospheric pressure is measured by the pressure sensor 24, which is provided in the pump passage 25. After the measurement of the atmospheric pressure by the pressure sensor 24, the ECU 3 calculates the altitude of the vehicle parking place. FIG. 1 shows a state where the coil 231 is not energized.

After the measurement of the atmospheric pressure, the ECU 3 energizes the coil 231 of the switching valve 23. When the coil 231 is energized, the switching valve 23 moves toward the right side in FIG. 1. Therefore, the switching valve 23 interrupts the communication between the air passage 28 and the canister channel 21, and causes the canister channel 21 to communicate with the pump passage 25. At this time, a movable core 233 moves in an inside of the switching valve 23 and then contacting a fixed core 232. Thereby, noises are generated by vibration of the contact between the movable core 233 and the fixed core 232. The generated noises are absorbed by the filter 30, which is arranged at the vicinity of the fuel vapor leakage sensing unit 20. In addition, the noises transmitted to an inside of the housing 32 are reduced by a sound-absorbing function of the housing 32.

When a pressure increase caused by a fuel vapor generation in the inside of the fuel tank 10 is detected by the pressure sensor 24, the ECU 3 stops energizing the coil 231 of the switching valve 23. After the energizing the coil 231 is stopped, the pump passage 25 communicates with the canister channel 21 and the air passage 28 via the bypass passage 26.

Then, the pump 22 is energized, and the pressure of the inside of the pump passage 25 is reduced by the operation of the pump 22. Therefore, the air from the air passage 28 flows into the pump passage 25 through the bypass passage 26. The air flowing into the pump passage 25 is throttled by the orifice 27 of the bypass passage 26, thereby the inner pressure of the pump passage 25 is reduced. After the inner pressure of the pump passage 25 is reduced to a predetermined value that corresponds to an opening area of the orifice 27, the inner pressure of the pump passage 25 reaches a constant value. At this time, the pump 22 compresses air and discharging the compressed air, thereby noises are generated by the operation of the pump 22 and radiated to an outside of the pump 22. In addition, noises are generated by the vibration caused by the operation of the pump 22, and are transmitted to the inside of the housing 32. The radiated noises and the transmitted noises are absorbed by the filter 30, which is arranged at the vicinity of the fuel vapor leakage sensing unit 20. The noises transmitted to the inside of the housing 32 are reduced by the sound-absorbing function of the housing 32. The measured inner pressure of the pump passage 25 is recorded as the reference pressure. After the measurement of the reference pressure is completed, the operation of the pump 22 is stopped.

When the reference pressure is detected, the coil 231 of the switching valve 23 is energized again. Then, this interrupts the communication between the air passage 28 and the canister channel 21, and causes the canister channel 21 to communicate with the pump passage 25. Thereby, the fuel tank 10 communicates with the pump passage 25, and the inner pressure of the pump passage 25 becomes same as that of the fuel tank 10. At this time, the noises caused by the vibration of parts of the switching valve 23 are transmitted out of the switching valve 23. The transmitted noises are absorbed by the filter 30, which is arranged at vicinity of the fuel vapor leakage sensing unit 20. In addition, the noises transmitted to the inside of the housing 32 are reduced by the sound-absorbing function of the housing 32.

When the canister channel 21 and pump passage 25 are communicated with each other, the pump 25 is operated and the inner pressure in the fuel tank 10 is reduced. At this time, the pump 22 compresses the air and discharges the compressed air, thereby the noises generated by the operation of the pump 22 are radiated outside. In addition, the noises generated by the vibration are transmitted to the inside of the housing 32. The radiated noises and the transmitted noises are absorbed by the filter 30, which is arranged at the vicinity of the fuel vapor leakage sensing unit 20. In addition, the noises transmitted to the inside of the housing 32 are reduced by the sound-absorbing function of the housing 32.

When the inner pressure in the fuel passage 25, i.e., the inner pressure in the fuel tank 10, becomes lower than the pre-measured reference pressure by keeping the operation of the pump 22, it is determined that the leakage of the air, which includes the fuel vapor from the fuel tank 10, is less than tolerance. That is, when the inner pressure in the fuel tank 10 becomes lower than the reference pressure, it is considered that there is no intrusion of air from an outside of the fuel tank 10 to an inside thereof, or the amount of the flow of the intrusion air is smaller than that of the air which can pass through the reference orifice 27. In this case, it is judged that the air tightness of the inside of the fuel tank 10 is achieved.

On the other hand, if the inner pressure in the fuel tank 10 does not become lower than the pre-measured reference pressure by continuing to operate the pump 22, it is judged that the leakage of the air, which includes the fuel vapor from the fuel tank 10, is greater than the tolerance. That is, if the inner pressure in the fuel tank 10 does not become lower than the reference pressure, it is considered that there is the intrusion of the air from the outside of the fuel tank 10 to the inside thereof. In this case, it is determined that the air tightness of the inside of the fuel tank 10 is not achieved reliably.

After detecting the intrusion of the air from the outside of the fuel tank 10, i.e., the leakage of the air that includes the fuel vapor from the fuel tank 10, the energizing the pump 22 and the switching valve 23 are stopped. After the ECU 3 detects that the inner pressure in the pump passage 25 is recovered to the atmospheric pressure, it stops the operation of the pressure sensor 24, thereby the fuel vapor leakage inspection process is finished.

### (Effects)

Next, effects of the fuel vapor leakage inspection apparatus 2 according to the first embodiment will be described.

(1) In the fuel vapor leakage inspection apparatus 2, the filter 30 is arranged at the vicinity of the fuel vapor leakage sensing unit 20. Therefore, at the time of detecting the fuel vapor leakage, the operating noises generated from the pump 22 and the switching valve 23 within the fuel vapor leakage sensing unit 20 is absorbed by the filter 30. Thereby, the operating noise generated within the fuel vapor leakage sensing unit 20 can be reduced.

(2) The fuel vapor leakage sensing unit 20 and the filter 30 are accommodated by the housing 32. At this time, the fuel vapor leakage inspection apparatus 2 is modularized by using the one housing 32, thereby high stiffness of the fuel vapor leakage inspection apparatus 2 is achieved. Therefore, the transmitted noises, which are caused by the vibration generated in the operation of the pump 22 and the switching valve 23, can be limited. Thereby, the transmitted noise generated within the fuel vapor leakage sensing unit 20 can be reduced by the high stiffness of the fuel vapor leakage inspection apparatus 2.

(3) The fuel vapor leakage sensing unit 20 and the filter 30 are accommodated by the housing 32. Therefore, the filter 30 and the fuel vapor leakage sensing unit 20 can be connected to each other without using parts for the connection. Thereby, the number of the parts, which are necessary for assembling the fuel vapor leakage inspection apparatus 2, can be reduced.

(4) By forming the housing interior space 321 as the air passage 28, the air flowing through the filter 30 directly flows into and out of the switching valve 23 of the fuel vapor leakage sensing unit 20. Therefore, an air-flow resistance, which is caused by the air flowing into and out of the fuel vapor leakage sensing unit 20, can be reduced.

(5) The filter 30 is arranged within the housing interior space 321 at the side that is opposite from the canister attachment portion 211. The connector 29, which receives a power supply from an outside of the fuel vapor leakage sensing unit 20, is arranged on an outer wall 382 of the housing 32, which is opposite from the canister attachment portion 211. At this time, the filter 30 is arranged around three sides, which are the upper side 33, the front side 36 and the back side 37 of the connector 29. Therefore, at the time of connecting an external terminal to the connector, which supply the power provided from the outside of the fuel vapor leakage sensing unit 20 thereto, the positioning of the connector can be easily adjusted on the housing 32, so that the connection of the external terminal and the connector can be easily performed.

(6) The air communicating passage 391, which causes the housing interior space 391 to communicate with the air around the outside of the housing 32, has the labyrinth structure. The operating noises generated within the fuel vapor leakage sensing unit 20 are discharged out of the housing 32 through the filter 30. At this time, the operating noises through the filter 30 are reduced due to repeated reflection with wall surface at the bent portion in the air communicating passage 391. Thereby, the operating noise generated within the fuel vapor leakage sensing unit 20 can be reduced.

### Second Embodiment

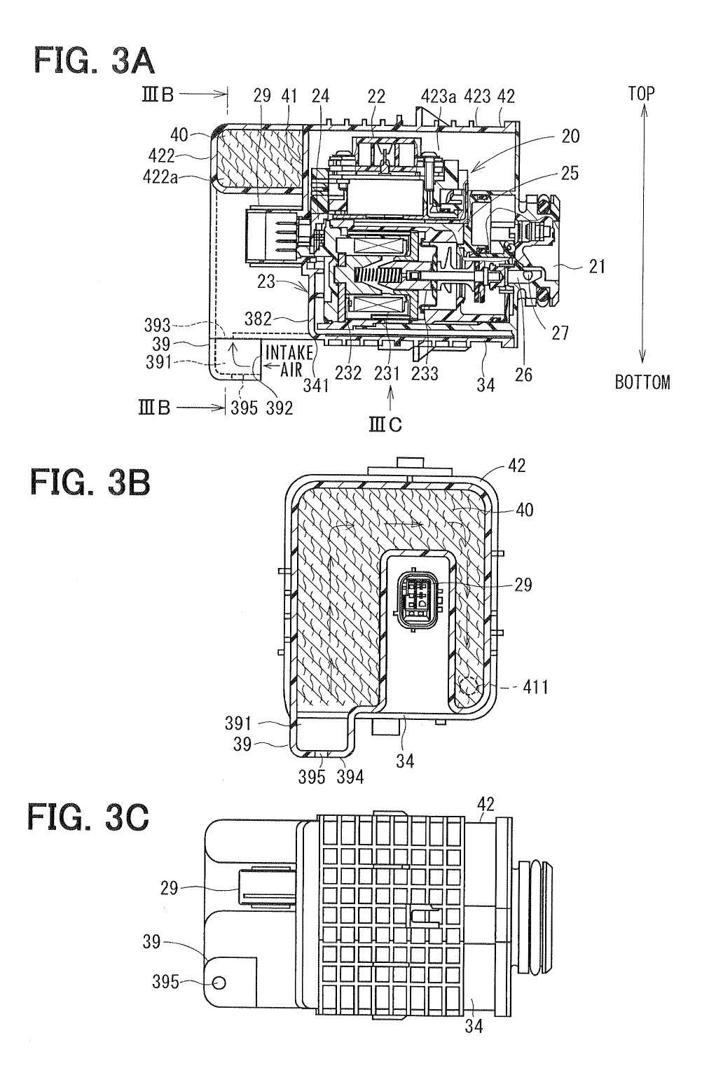

A second embodiment of the present invention will be described with reference to FIGS. 3A, 3B and 3C. A housing of the second embodiment has a wall that is not included in the first embodiment. The wall divides the filter and the fuel vapor leakage sensing unit from each other. In the following embodiments, the components that are similar to those of the first embodiment will be indicated by the same reference numerals and will not be described to avoid redundancy.

In the second embodiment of the present invention, as shown in FIG. 3A, a filter 40 is accommodated within a housing 42 at a side which is opposite from the canister attachment portion 211. A wall 41 divides the fuel vapor leakage sensing unit 20 and the filter 40 from each other. Therefore, the housing 42 includes a filter housing 422 and a sensing unit housing 42. The filter housing 422 accommodates the filter 40. The sensing unit housing 42 accommodates the fuel vapor leakage sensing unit 20. As shown in FIG. 3B, the wall 41 has an opening 411. The opening 411 causes an interior space 422a of the filter housing 422 to communicate with an interior space 423a of the sensing unit housing 423. The opening 411 is arranged at a location in a manner that the distance of air flow passing through the air communicating portion 39 is maximized. Arrows shown in FIGS. 3A and 3B indicates the flow of air passing through the filter 40.

The filter 40 and the fuel vapor leakage sensing unit 20 are accommodated in the interior space 422a of the filter housing 422 and the interior space 423a of the sensing unit housing 423, respectively. Thus, the filter housing 422 and the sensing unit housing 423 can be divided. Therefore, at the time of maintenance of the fuel vapor leakage inspection apparatus 2, the filter housing 422 that accommodates the filter 40 can be detached from the fuel vapor leakage inspection apparatus 2. As a result, in addition to the effects (1) to (6) of the first embodiment, the maintenance of the fuel vapor leakage inspection apparatus 2 can be easily performed.

### Third Embodiment

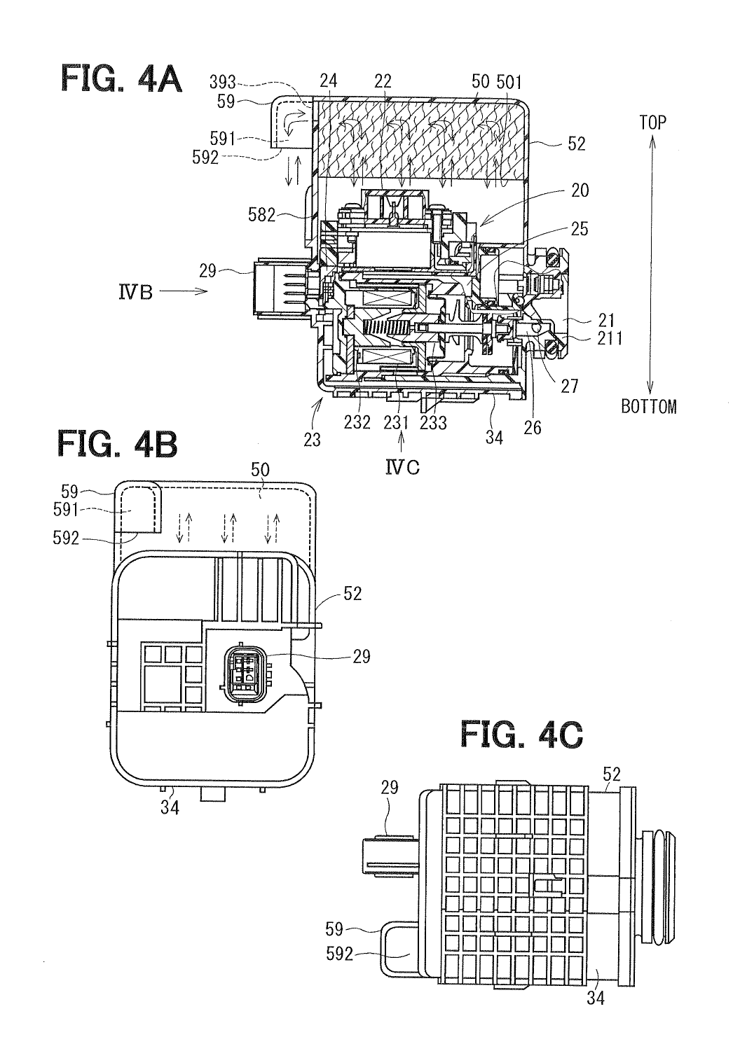

A third embodiment of the present invention will be described with reference to FIGS. 4A, 4B, and 4C. In the third embodiment, the installation location of the filter in the housing is different from that of the first embodiment.

As shown in FIG. 4A, a filter 50 is accommodated within a housing 52 at an upper side thereof. An air communicating portion 59 defines an air communicating passage 591, and is arranged on a wall 582, which is opposite from the canister attachment portion 211. An air opening 592 of the air communicating passage 591 opens toward a bottom of the housing 52. An air flow passing through the filter 50 directs from the air communicating passage 591 to the fuel vapor leakage sensing unit 20 through a whole area of a lower face 501 of the filter 50, which faces to the bottom of the housing 52. Arrows shown in FIGS. 4A and 4B indicates the air flow passing through the filter 50.

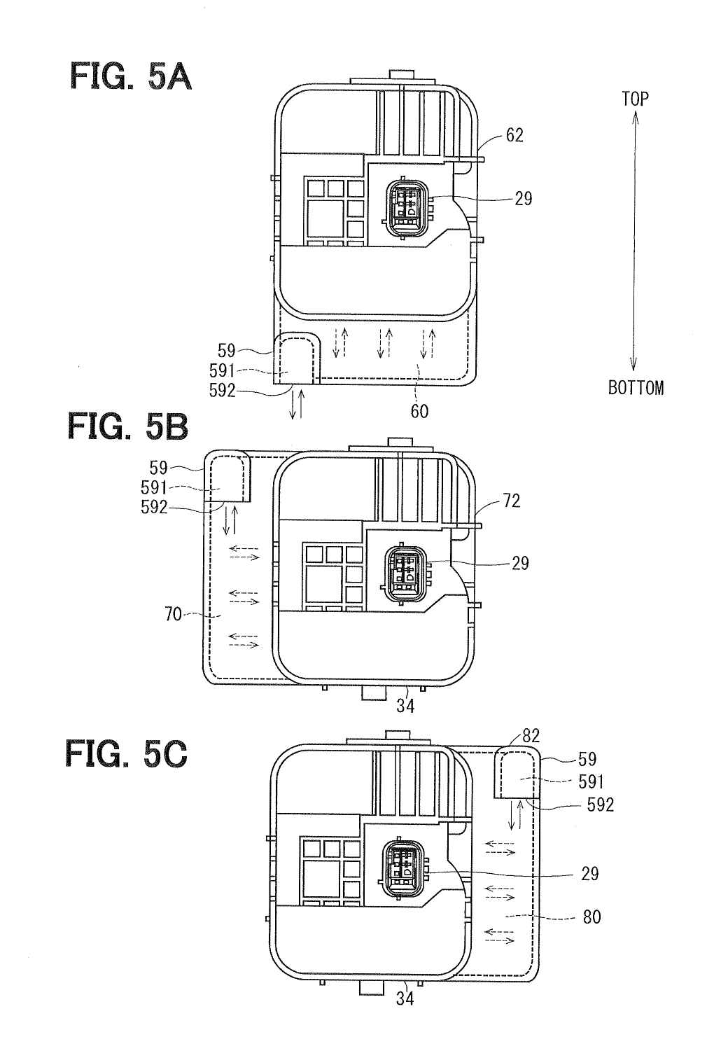

FIG. 5A shows a modification example of the third embodiment where a filter 60 is provided at a lower side of a housing 62. FIG. 5B shows a modification example of the third embodiment where a filter 70 is provided at a back side of a housing 72. FIG. 5C shows a modification example of the third embodiment where a filter 80 is provided at a front side of a housing 82. Arrows shown in FIGS. 5A, 5B and 5C indicate the flow of the air passing through the filter 60, 70, 80.

In the third embodiment, the filter 50, 60, 70, 80 is provided adjacent to the pump 22 and the switching valve 23 that generate the operating noises. The filter 50, 60, 70, 80 absorbs the generated operating noises. Thereby, the generated operating noises are effectively absorbed. As a result, in addition to the effects (1) to (6) of the first embodiment, the operating noise generated in the fuel vapor leakage inspection apparatus 2 can be effectively absorbed.

### Fourth Embodiment

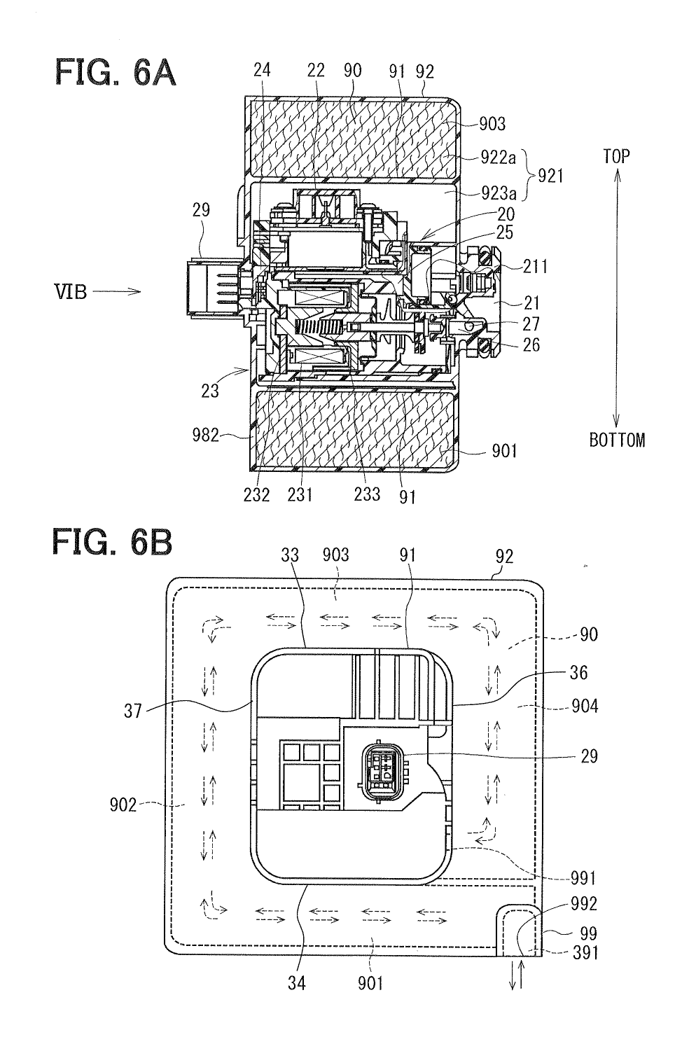

A fourth embodiment of the present invention will be described with reference to FIGS. 6A and 6B. In the fourth embodiment, the installation location of the filter in the housing is different from that of the second embodiment.

In the fourth embodiment, as shown in FIG. 6B, a filter 90 is provided at the upper side 33, the lower side 34, the front side 36, and the back side 37 of a housing 92. A lower side filter 901, which is located in the lower side of the housing 92, communicates with a back side filter 902, which is located in the left side of the housing 92 in FIG. 6B. The back side filter 902 communicates with an upper side filter 903, which is located in the upper side of the housing 92. The upper side filter 903 communicates with a front side filter 904, which is located in the right side of the housing 92 in FIG. 6B. A wall 91 is provided at a location between the filter 90 and the fuel vapor leakage sensing unit 20. The wall 91 defines an interior space 921 of the housing 92, thereby interior spaces 922a, 923a are formed. The interior space 922a accommodates the filter 90. The interior space 923a accommodates the fuel vapor leakage sensing unit 20. The front side 36 of the wall 91 has openings 991. The openings 991 cause the interior space 922a to communicate with the interior space 923a.

An air communicating portion 99 is arranged on an outer wall 982, which is opposite from the canister attachment portion 211 relative to the housing 92, and located at the lower front side (the lower right side in FIG. 6B) in the housing 92. An air opening 992 of the air communicating portion 99 opens toward a bottom of the housing 92. As shown in FIG. 6B, the air flowing through the fuel vapor leakage sensing unit 20 flows around the outer periphery of the fuel vapor leakage sensing unit 20, and passes through the filter 90. The air flows between the interior spaces 922a, 923a through the opening 991. Arrows shown in FIG. 6B indicate the flow of the air passing through the filter 90.

The operating noise generated in the fuel vapor leakage sensing unit 20 is absorbed by the filter 90, which is located around the outer periphery of the fuel leakage sensing unit 20 as show in FIG. 6B. In addition, the transmitted noise caused by the vibration of the fuel vapor leakage sensing unit 20 can be reduced by the housing 92. As a result, in addition to the effects (1) to (4) and (6) of the first embodiment, the noise can be further reduced.

### Other Embodiment

(I) In above-described embodiments, the canister attachment portion 221 of the fuel vapor leakage sensing unit 20 can be installed on the lateral side of the outer wall of the canister 12. However, a location of the canister attachment portion 221, which corresponds to location of the canister 21, is not limited to this. The canister attachment portion 221 can be arranged in a location in the housing of the fuel vapor leakage sensing unit 20, which corresponding to an upper wall or a lower wall of the canister. In addition, the canister attachment portion 221 can be arranged in a pipe that connects to the canister 21.

(II) In the above-described embodiments, the detector for sensing the fuel vapor leakage of the inside of the fuel tank is the pressure sensor. However, the detector for sensing the fuel vapor leakage is not limited to this. The detector for sensing the fuel vapor leakage can be devices that detect an electric property of, for example, the current value of a motor driving a pump.

(III) In the first and second embodiment, the air communicating portion is arranged on the lower outer wall of the housing of the fuel vapor leakage inspection apparatus. However, the installation location of air communicating portion is not limited to this. The air communicating portion can be arranged in a location that is capable to be connected to the filter, for example, the outer wall of the front side or back side of the housing.

(IV) In the first and second embodiment, the filter arranged around the connector is provided at three sides, i.e., the upper side, the front side and the back side of the connector. However, the installation location of the filter is not limited to this. The filter can be arranged at, for example, the lower side and the both lateral side (the front side and the back side) of the connector or the lower side and the front side of the connector.

(V) In the third embodiment, the air communicating portion is provided on the outer wall that is opposite from the canister attachment portion of the housing of the fuel vapor leakage inspection apparatus. However, the installation location of the air communicating portion is not limited to this. The air communicating portion can be arranged on, for example, the upper side outer wall of the housing or the front side lateral wall of the housing.

(VI) In the third embodiment, the housing of the fuel vapor leakage inspection apparatus does not have the wall for dividing the interior space of the sensing unit housing. However, the wall can be arranged to divide the filter and the fuel vapor leakage sensing unit in the fuel vapor leakage inspection apparatus.

(VII) In the second and fourth embodiments, the air opening and the openings of the wall, which divides the interior space of the housing of the fuel vapor leakage inspection apparatus, are arranged such that the distance of the air flow passing through the inside of the filter can be maximized. However, the location of the air opening and the openings of the wall is not limited to this.

(VIII) In the above-described embodiments, the air opening of the air communicating portion opens toward the bottom of the fuel vapor leakage inspection apparatus. However, the opening direction of the air opening is not limited to this. The opening direction of the air opening can be face toward the upper side or the lateral side of the fuel vapor leakage inspection apparatus.

(IX) In the above-described embodiments, the air communicating portion has the labyrinth structure including the one bent portion. However, the number of the bent portion in the inside of the labyrinth structure is not limited to this. The multiple bent portions may be formed in the labyrinth structure.

Additional advantages and modifications will readily occur to those skilled in the art. The invention in its broader terms is therefore not limited to the specific details, representative apparatus, and illustrative examples shown and described.

What is claimed is:

1. A fuel vapor leakage inspection apparatus, which detects a leakage of a fuel vapor from a fuel tank through a canister that absorbs the fuel vapor, the fuel vapor leakage inspection apparatus comprising:
a canister attachment portion that includes a canister passage communicating with an inside of the canister;
an air passage having a first end connected to communicate with the canister passage and a second end connected with atmosphere;
a pumping device that increases and decreases an inside pressure of the canister, wherein one end of the pumping device is connected to communicate with the canister passage and the other end of the pumping device is connected to the air passage;
a switching valve that switches the canister passage to communicate with the air passage or the pumping device;
a bypass passage, wherein one end of the bypass passage is connected to the canister passage and the other end of the bypass passage is connected to a passage defined between the pumping device and the switching valve;
a throttle that is provided in the bypass passage;
a housing that defines the air passage and the bypass passage, and accommodates the pumping device, the switching valve and the throttle; and
a filter that is provided in the air passage and is accommodated in the housing.

2. The fuel vapor leakage inspection apparatus according to claim 1, wherein the filter is arranged at a lateral side of the housing, which is opposite from the canister attachment portion.

3. The fuel vapor leakage inspection apparatus according to claim 1, wherein the filter is located on at least one of upper side, lower side, and lateral side other than a lateral side having the canister attachment portion in the housing.

4. The fuel vapor leakage inspection apparatus according to claim 1, wherein the canister attachment portion is to be installed at lateral side of an outer wall of the canister.

5. The fuel vapor leakage inspection apparatus according to claim 1, wherein the housing includes a wall that separates the filter from the pumping device, the switching valve and the throttle.

6. The fuel vapor leakage inspection apparatus according to claim 1, wherein the second end of the air passage has a labyrinth structure including at least one bent portion.
